(19) United States
(12) Patent Application Publication
(10) Pub. No.: US 2014/0090303 A1
(43) Pub. Date: Apr. 3, 2014

(54) Door Bottom-Gap Fix

(71) Applicant: Rachelle Munson, San Clemente, CA (US)

(72) Inventor: Rachelle Munson, San Clemente, CA (US)

(21) Appl. No.: 12/411,202

(22) Filed: Mar. 25, 2009

(51) Int. Cl. E06B 7/16

(52) U.S. Cl. CPC E06B 7/16
USPC 49/490.1; 49/475.1

(57) ABSTRACT

A door extending device to cooperate with the door may include a longitudinal U-shaped member or a substantially rectangular member to cover a gap between a support surface and a bottom of the door and an adhesive being positioned in a longitudinal channel of the longitudinal U-shaped member or the substantially rectangular member to connect to the door extending device. The adhesive may be a continuous strip within the longitudinal channel, and the adhesive may be a non-continuous strip within the longitudinal channel. The longitudinal U-shaped member may include a leading exterior surface which may include decorative indicia and the longitudinal U-shaped member may include a trailing exterior surface which may include decorative indicia.

### FIELD OF THE INVENTION

The present invention relates to trim accessories for walls and doors and more particularly to a trim accessory for a door.

### BACKGROUND

Both interior and exterior doors generally have a small gap which extends around the periphery of the door in order to accommodate shrinkage and expansion of the door. A small gap generally is unavoidable and results in an eyesore if the gap is sufficiently large.

For interior doors, the gap across the bottom of the interior door may be increased in order to accommodate a thick carpet which may extend through the doorway. In order to achieve this increased gap, a bottom section of the door may be removed to prevent the thick carpet from interfering with the operation of the door. A problem arises after the bottom portion has been removed from the door, the thick carpet is replaced with a relatively thin carpet or Hardwood or linoleum or other such floor covering. This may result in a sufficiently large gap which may be an eyesore.

One solution is to replace the door which may cost several hundred dollars. Generally, more than one room may be affected by the change in carpet and consequently there may be in need to replace several doors. This could increase the cost to several thousand dollars.

Additionally, the large-gap may cause privacy concerns especially when the affected door is a door to a bathroom or changing room.

Furthermore, the large gap may promote heat loss or air-conditioning loss.

Consequently, there is a need for a relatively inexpensive yet visually attractive solution to reduce if not eliminate the large gap problem. Furthermore, it would be desirable if the solution could be achieved without removing the door from the hinges.

### SUMMARY

A door extending device to cooperate with the door may include a longitudinal U-shaped member or a substantially rectangular member to cover a gap between a support surface and a bottom of the door and an adhesive being positioned in a longitudinal channel of the longitudinal U-shaped member or the substantially rectangular member to connect to the door extending device.

The adhesive may be a continuous strip within the longitudinal channel or on the top surface, and the adhesive may be a non-continuous strip within the longitudinal channel or on the top surface.

The longitudinal U-shaped member or the rectangular member may include a leading exterior surface which may include decorative indicia and the longitudinal U-shaped member may include a trailing exterior surface which may include decorative indicia.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an end view of the door extending device and door;

FIG. 2 illustrates a perspective view of the door extending device;

FIG. 3 illustrates a top view of the door extending device with continuous adhesive;

FIG. 4 illustrates a top view of the door extending device with non-continuous adhesive.

FIG. 5 illustrates an exploded view of the door extending device and door;

FIG. 6 illustrates a front view of the door and door extending device;

FIG. 7 illustrates a perspective view of the door extending device;

FIG. 8 illustrates a top view of the door extending device;

FIG. 9 illustrates another top view of the door extending device

FIG. 10 illustrates an end view of the door extending device;

FIG. 11 illustrates a front view of the decorative indicia such as clavos;

FIG. 12 illustrates an end view of the decorative indicia such as clavos.

### DETAILED DESCRIPTION

FIG. 1 illustrates an end view of the door extending device 100 of the present invention. The door extending device 100 may completely or partially eliminate the gap between the support surface 101 which may be the floor or rug and the bottom surface of the door 103 and may provide an aesthetically pleasing alternative to a large gap. The door extending device 100 may add to the privacy of the users by completely or partially eliminating the gap between the support surface 101 which may be the floor of a building or the ground surface and the door 103. Additionally, the door extending device 100 may reduce or eliminate heat and air-conditioning cooling from flowing between the rooms divided by the door 103. The door extending device 100 in addition to the above benefits may reduce light and noise.

FIG. 1 illustrates an end view of the door extending device 100 and illustrates that the door extending device 100 may be a substantially longitudinal U-shaped device which may include a leading upward extending member 105, a trailing upward extending member 107 and a bottom member 109. The leading upward extending member 105 may include a leading exterior surface 111 which may be connected to a leading top surface 113 which may be connected to a leading interior surface 115. The leading exterior surface 111 may be connected to a bottom exterior surface 117 and the leading interior surface 115 may be connected to a bottom interior surface 119. The bottom exterior surface 117 may be connected to a trailing exterior surface 131 and the bottom interior surface 119 may be connected to a trailing interior surface 133. FIG. 1 additionally illustrates the trailing top surface 114.

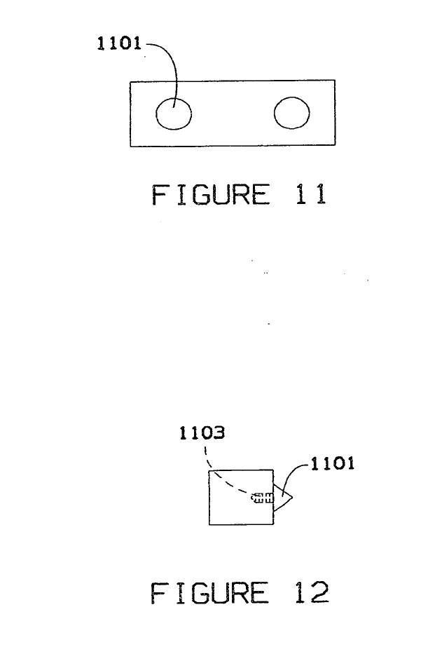

The leading exterior surface 111 and the trailing exterior surface 131 may include decorative indicia. The decorative indicia may be a sign, a distinctive mark, postal, text, numerals, a carved design, or a design which appears to be a carved design or other such design. The decorative indicia may be a clavos 1101 (as illustrated in FIGS. 11 and 12) which may be a hemisphere which may include a central attachment device 1103 such as a nail or screw or other appropriate attachment device. The decorative indicia may be integral with the leading exterior surface 111 or the trailing exterior surface 131 or may be applied and may be formed from wood, metal, plastic and may be painted

The door extending device 100 may be formed from wood, plastic, metal or other appropriate material. The door extending device 100 may be adapted to be reduced in size especially in the longitudinal direction in order to accommodate and customize different size doors 103.

The leading interior surface 115 may cooperate with the door leading exterior surface 135 and the trailing interior surface 133 may cooperate with the door trailing exterior surface 137 to provide a visually attractive presentation by providing a relatively snug fit. A friction fit may connect the door extending device to the door 103.

The door extending device 100 may be detachably connected to the door 103 with detachable adhesive 151 or alternatively may be permanently connected to the door 103 with a permanent adhesive or screws or bolts or other appropriate devices which may be placed on the bottom interior surface 119. The leading interior surface 115, the trailing interior surface 113 and the bottom interior surface 119 define a longitudinal channel which extends in the longitudinal direction of the door extending device 100. The bottom interior surface 119 may engage the door bottom exterior surface 131 and may be held in place by the detachable adhesive 151.

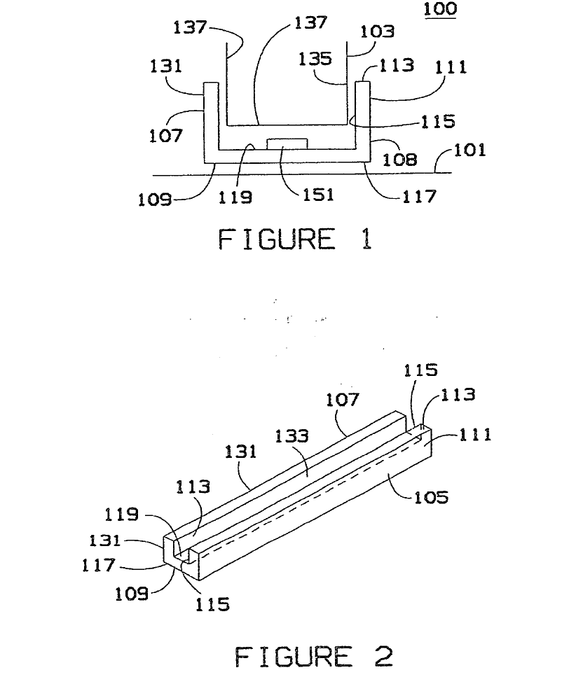

FIG. 2 illustrates a perspective view of the door extending device 100 and illustrates that the door extending device 100 may be a substantially longitudinal U-shaped device which may include a leading upward extending member 105, a trailing upward extending member 107 and a bottom member 109. The leading upward extending member 105 may include a leading exterior surface 111 which may be connected to a leading top surface 113 which may be connected to a leading interior surface 115. The leading exterior surface 111 may be connected to a bottom exterior surface 117 and the leading interior surface 115 may be connected to a bottom interior surface 119. The bottom exterior surface 117 may be connected to a trailing exterior surface 131 and the bottom interior surface 119 may be connected to a trailing interior surface 133.

The leading interior surface 115 may cooperate with the door leading exterior surface 135 and the trailing interior surface 133 may cooperate with the door trailing exterior surface 137 to provide a visually attractive presentation by providing a relatively snug fit.

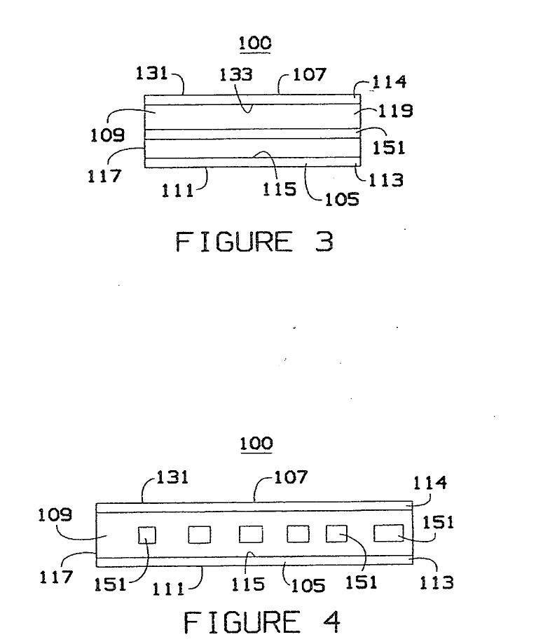

FIG. 3 illustrates a top view of the door extending device 100 and illustrates that the door extending device 100 may be a substantially longitudinal U-shaped device which may include a leading upward extending member 105, a trailing upward extending member 107 and a bottom member 109. The leading upward extending member 105 may include a leading exterior surface 111 which may be connected to a leading top surface 113 which may be connected to a leading interior surface 115. The leading exterior surface 111 may be connected to a bottom exterior surface 117 and the leading interior surface 115 may be connected to a bottom interior surface 119. The bottom exterior surface 117 may be connected to a trailing exterior surface 131 and the bottom interior surface 119 may be connected to a trailing interior surface 133. FIG. 3 illustrates that the adhesive 151 may be a continuous strip of adhesive.

The leading interior surface 115 may cooperate with the door leading exterior surface 135 and the trailing interior surface 133 may cooperate with the door trailing exterior surface 137 to provide a visually attractive presentation by providing a relatively snug fit.

FIG. 4 illustrates a top view of the door extending device 100 and illustrates that the door extending device 100 may be a substantially longitudinal U-shaped device which may include a leading upward extending member 105, a trailing upward extending member 107 and a bottom member 109. The leading upward extending member 105 may include a leading exterior surface 111 which may be connected to a leading top surface 113 which may be connected to a leading interior surface 115. The leading exterior surface 111 may be connected to a bottom exterior surface 117 and the leading interior surface 115 may be connected to a bottom interior surface 119. The bottom exterior surface 117 may be connected to a trailing exterior surface 131 and the bottom interior surface 119 may be connected to a trailing interior surface 133. FIG. 4 illustrates that the adhesive 151 may be a broken or non continuous strip or portions of adhesive.

The leading interior surface 115 may cooperate with the door leading exterior surface 135 and the trailing interior surface 133 may cooperate with the door trailing exterior surface 137 to provide a visually attractive presentation by providing a relatively snug fit.

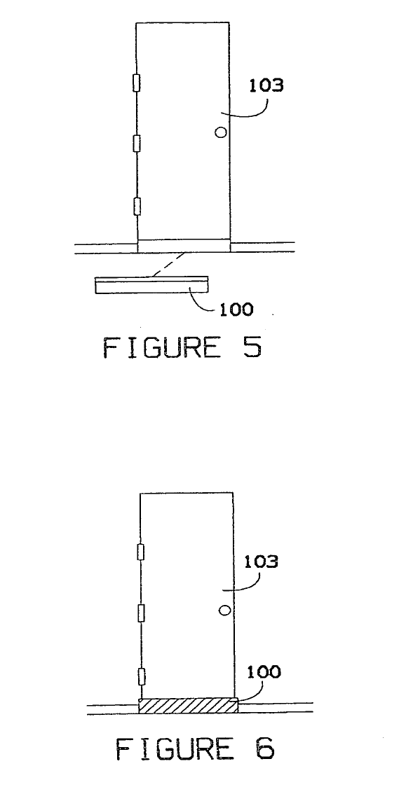

FIG. 5 illustrates the door extending device 100 being applied to the door 103.

FIG. 6 illustrates that the door extending device 100 has been applied to the door 103.

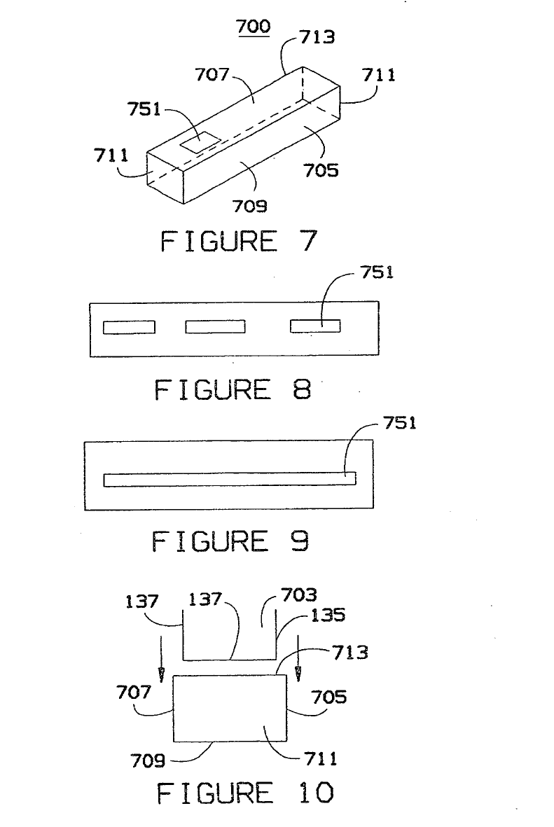

FIG. 7 illustrates a perspective view of a door extending device 700 which may be an elongated rectangular device which may correspond in width and depth to a door and which may include a leading surface 705 which may be connected to a top surface 713 which may be connected to a trailing surface 707. The leading surface 705 and the trailing surface 707 may be connected to a bottom surface 709 and may be connected to a end surface 711. Furthermore, detachable adhesive 751 or permanent adhesive may be positioned on the top surface 713.

FIG. 8 illustrates a top view of a door extending device 700 which may include a leading surface 705 which may be connected to a top surface 713 which may be connected to a trailing surface 707. The leading surface 705 and the trailing surface 707 may be connected to a bottom surface 709 and may be connected to a end surface 711. Furthermore, detachable adhesive 751 or permanent adhesive may be positioned as a non continuous strip on the top surface 713.

FIG. 9 illustrates a perspective view of a door extending device 700 which may include a leading surface 705 which may be connected to a top surface 713 which may be connected to a trailing surface 707. The leading surface 705 and the trailing surface 707 may be connected to a bottom surface 709 and may be connected to a end surface 711. Furthermore, detachable adhesive 751 or permanent adhesive which may be positioned as a continuous strip and may be positioned on the top surface 713.

FIG. 10 illustrates a end view of a door extending device 700 and door 703 and the door extending device 700 and may include a leading surface 705 which may be connected to a top surface 713 which may be connected to a trailing surface 707. The leading surface 705 and the trailing surface 707 may be connected to a bottom surface 709 and may be connected to a end surface 711. Furthermore, detachable adhesive 751 or permanent adhesive may be positioned on the top surface 713.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A door extending device to cooperate with the door, comprising:
a longitudinal U-shaped member to cover a gap between a support surface and a bottom of the door;
an adhesive being positioned in a longitudinal channel of the longitudinal U-shaped member to connect to the door extending device.

2) A door extending device to cooperate with the door as in claim 1, wherein the adhesive is a continuous strip within the longitudinal channel.

3) A door extending device to cooperate with the door as in claim 1, wherein the adhesive is a noncontinuous strip within the longitudinal channel.

4) A door extending device to cooperate with the door as in claim 1, wherein the longitudinal U-shaped member includes a leading exterior surface which may include decorative indicia.

5) A door extending device to cooperate with the door as in claim 1, wherein the longitudinal U-shaped member includes a trailing exterior surface which may include decorative indicia.

6) A door extending device to cooperate with the door, comprising:
a longitudinal substantially rectangular member to cover a gap between a support surface and a bottom of the door;
an adhesive being positioned in the top surface of the substantially rectangular member to connect to the door extending device.

7) A door extending device to cooperate with the door as in claim 6, wherein the adhesive is a continuous strip.

8) A door extending device to cooperate with the door as in claim 6, wherein the adhesive is a noncontinuous strip.

9) A door extending device to cooperate with the door as in claim 6, wherein the longitudinal substantially rectangular member includes a leading exterior surface which may include decorative indicia.

10) A door extending device to cooperate with the door as in claim 6, wherein the longitudinal substantially rectangular member includes a trailing exterior surface which may include decorative indicia.
